(19) United States
(12) Patent Application Publication
(10) Pub. No.: US 2018/0010768 A1
(43) Pub. Date: Jan. 11, 2018

(54) METHOD FOR FABRICATING SOLID-STATE LIGHTING BODY

(71) Applicant: Fameson Technology Co., Ltd., Taipei City (TW)

(72) Inventor: Rong-Seng CHANG, Taipei City (TW)

(21) Appl. No.: 15/203,430

(22) Filed: Jul. 6, 2016

(51) Int. Cl. F21V 9/16

(52) U.S. Cl. CPC F21V 9/16

(57) ABSTRACT

A method for fabricating a solid-state lighting body, which differs from a conventional solid-state lighting body doping lighting powder in a filling material during a high-temperature calcining process, and mixes lighting powder with either organic powder or inorganic powder to form liquid mixture, thereby fabricating the solid-state lighting body in pour molding. The method is performed at a lower temperature without the high energy consumption and high equipment cost. The solid-state lighting body is easily molded at a low temperature without damaging the structure properties of the lighting powder and decreasing the lighting efficiency. As a result, the solid-state lighting body of the present invention has very good heat-resistant abilities and efficiently prevents lighting elements from high-temperature cracking resulted from long-term illumination, so as to increase use life and reliability.

### BACKGROUND OF THE INVENTION

### Field of the Invention

The present invention relates to a lighting material, particularly to a method for fabricating a solid-state lighting body which is molded at a low temperature and maintains material properties thereof.

### Description of the Related Art

During a conventional fabrication process of white-light lighting elements, sealing glue mixed by fluorescent powder and glue is uniformly coated on surfaces of light-emitting diodes (LEDs) using dispensing or screen printing, and then the LEDs are packaged and molded. For example, the Taiwan patent No. 583777 disclosed a method for fabricating a white-light LED. In the patent, glue having fluorescent powder is coated on the surfaces and surroundings of a LED die using screen printing, and then the LED die is baked, hardened and molded. However, the process of mixing and coating fluorescent powder and glue is not only complicated and time-consuming, but also easily results in a problem with uneven distribution of fluorescent powder.

Accordingly, a solid-state fluorescent body is recently developed to replace the sealing glue mixed by fluorescent powder and glue. For example, the Taiwan patent publication Nos. 201440255 and 201503416 disclosed a method for fabricating a white-light LED, which uses a solid-state fluorescent body to replace the sealing glue mixed by fluorescent powder and glue. Wherein, the solid-state fluorescent body is a ceramics fluorescent body consisting of ceramics and fluorescent powder. Alternatively, the solid-state fluorescent body is a glass fluorescent body consisting of glass and fluorescent powder. The solid-state fluorescent body is easily-fabricated and time-saving, and increases reliability and use life of white-light lighting elements without causing the problem with uneven distribution of fluorescent powder.

However, limited by the present technology, the solid-state fluorescent body is fabricated at a high temperature in trivial steps. As to the abovementioned patents, when ceramics or glass are calcined and molded, fluorescent powder is added to the ceramics or glass whereby the fluorescent powder is uniformly distributed and doped to fabricate a ceramics fluorescent body or a glass fluorescent body. Owning to the high-temperature fabrication process, lattice structures of the fluorescent powder are damaged to change lighting properties, such as shifting lighting wavelengths or degrading lighting efficiency.

Therefore, the present invention provides a method for fabricating the solid-state lighting body, which is performed under simplicity and low-temperature operation conditions without damaging lattice structures of lighting material and affecting lighting properties thereof, and which has heat-resistant abilities and endures long-term illumination, and which ideally suits to apply to daily illumination.

### SUMMARY OF THE INVENTION

To overcome the abovementioned problems, a primary objective of the present invention is to provide a method for fabricating a solid-state lighting body, which mixes lighting material with either organic powder or inorganic powder to form a mixed material, and which uses the mixed material to fabricate the solid-state lighting body using pour molding. Due to the fact that the solid-state lighting body is easily molded at a low temperature, the structure and lighting properties of the lighting powder are not damaged. The solid-state lighting body has very good heat-resistant abilities and efficiently prevents lighting elements from high-temperature cracking resulted from long-term illumination, so as to increase use life and reliability.

Another objective of the present invention is to provide a method for fabricating a solid-state lighting body, which is performed at room temperature or low temperature, and which has a simple fabrication process without high energy consumption, so as to decrease the cost of equipment and fabrication processes.

To achieve the abovementioned objectives, the present invention provides a method for fabricating a solid-state lighting body. Firstly, lighting powder of 3-20 percentage weight (wt %) and inorganic powder of 50-97 wt % are mixed to form a mixed material of 100 wt %. The lighting powder is fluorescent powder, phosphorescence powder or a combination of these, and the inorganic powder comprises calcium sulfate, and either of calcium oxide or silicon dioxide. Then, the mixed material and a solvent are uniformly mixed to form a liquid mixture. Then, the liquid mixture is poured into a mold whereby the liquid mixture solidified and molded into the solid-state lighting body which is stimulated by a light source of a lighting element to generate visible light.

The present invention provides another method for fabricating a solid-state lighting body. Firstly, lighting powder of 3-20 wt % and organic powder of 50-97 wt % are mixed to form a mixed material of 100 wt %. The lighting powder is fluorescent powder, phosphorescence powder or a combination of these, and the organic powder is silicone rubber or epoxy adhesive. Then, the mixed material and a solvent are uniformly mixed to form a liquid mixture. Then, the liquid mixture is poured into a mold whereby the liquid mixture solidified and molded into the solid-state lighting body.

In brief, using the method for fabricating the solid-state lighting body of the present invention, lighting powder is mixed with either inorganic powder or organic powder, and then a solvent is added to them to form liquid mixture which is poured into a mold, and then the liquid mixture is solidified and molded into the solid-state lighting body. The present invention has a simple fabrication process and simple equipment, wherein mixing, pouring and solidifying steps are performed at room temperature or low temperature. The present invention can achieve low energy consumption and save a cost without damaging the structure properties of the lighting powder, and provides suitable lighting wavelengths and better lighting efficiency. As a result, the solid-state lighting body of the present invention possesses good lighting properties and heat-resistant abilities and widely applies to daily illumination of long-term use.

Below, the embodiments are described in detail in cooperation with the drawings to make easily understood the technical contents, characteristics and accomplishments of the present invention.

### BRIEF DESCRIPTION OF THE DRAWINGS

FIG. 1 is a flowchart diagram schematically showing a method for fabricating a solid-state lighting body according to the first embodiment of the present invention;

FIG. 2 is a diagram schematically showing a pour molding step of a method for fabricating a solid-state lighting body according to an embodiment of the present invention;

FIG. 3A and FIG. 3B are diagrams schematically showing use of reflected and transparent solid-state lighting bodies according to an embodiment of the present invention; and

FIG. 4 is a flowchart diagram schematically showing a method for fabricating a solid-state lighting body according to the second embodiment of the present invention.

### DETAILED DESCRIPTION OF THE INVENTION

In order to clearly disclose the technical features of the method for fabricating a solid-state lighting body of the present invention, specific embodiments are introduced as below in cooperation with figures, so as to obviously detail the technical features of the present invention.

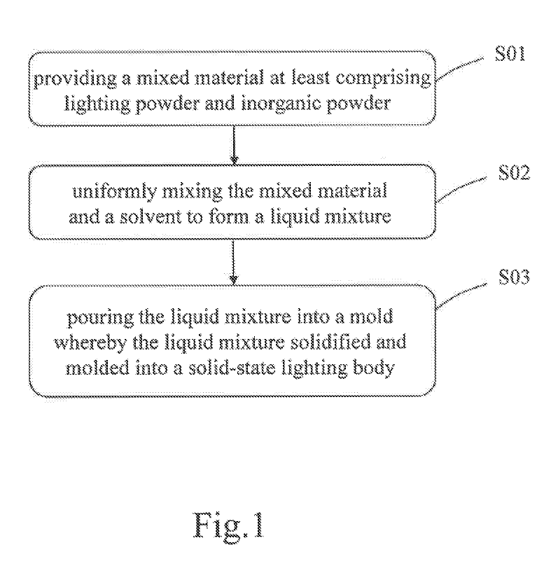

Refer to FIG. 1 which is a flowchart diagram schematically showing a method for fabricating a solid-state lighting body according to the first embodiment of the present invention. The steps are detailed as below.

Firstly, in Step S01, lighting powder and inorganic powder are uniformly mixed to form a mixed material. Based on the mixed material of percentage weight (wt %) of 100%, the lighting powder has percentage weight of 3-20 wt % and the inorganic powder has percentage weight of 50-97 wt %. Further, the mixed material comprises glass powder of at most 30 wt %. The lighting powder is selected from fluorescent powder or phosphorescence powder of various lighting colors. For example, the fluorescent powder is yellow fluorescent powder, green fluorescent powder or red fluorescent powder, but the present invention is not limited thereto. Certainly, fluorescent powder and phosphorescence powder are mixed in a fixed ratio to form the lighting powder. The inorganic powder comprises calcium sulfate, and either of calcium oxide or silicon dioxide. The inorganic powder comprises calcium sulfate of 80-97 wt %, and either of calcium oxide or silicon dioxide of 3-20 wt % based on the inorganic powder of 100 wt %.

Then, in Step S02, the mixed material and a solvent are uniformly mixed to form a liquid mixture. In the embodiment, a volume ratio of the mixed material to the solvent ranges from 40:50 to 50:50, and the solvent is water. During a process of forming the liquid mixture, ball milling is performed on the liquid mixture at a temperature of 10-40° C. for 2-4 hours, whereby the mixed material is uniformly distributed in the liquid mixture.

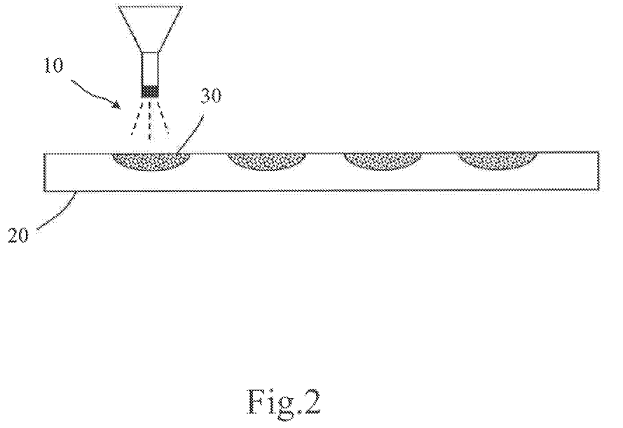

Then, refer to FIG. 1 and FIG. 2. In Step S03, the liquid mixture 10 is poured into a mold 20 at a room temperature, so that the liquid mixture 10 is solidified and molded to fabricate a final product of the solid-state lighting body 30. Wherein, the mold 20 comprises ceramics, plastic or metal. Besides, in the step of solidifying and molding the liquid mixture 10, the liquid mixture 10 poured into the mold 20 is naturally dried in a shade at a room temperature for 24 hours. Alternatively, the liquid mixture 10 poured into the mold 20 is slowly dried by heat at a temperature of 50° C. for 8 hours.

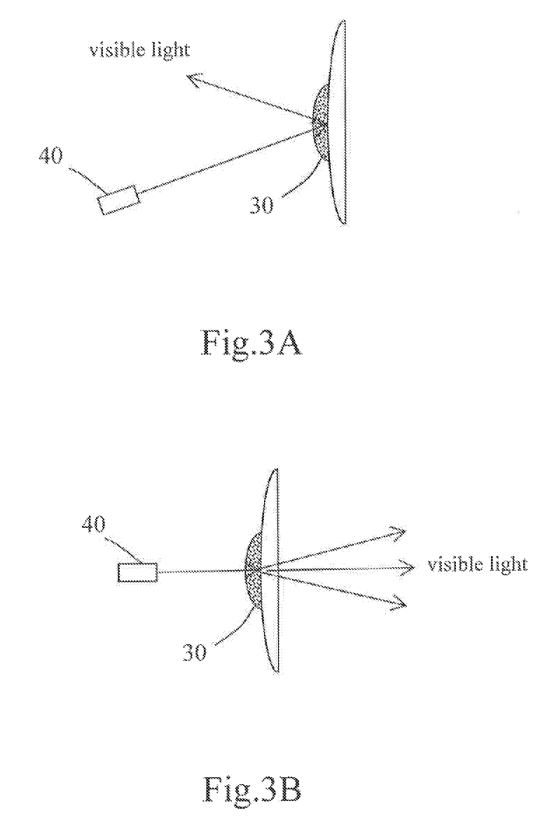

Finally, the liquid mixture poured into the mold is demolded, as shown in FIG. 3A and FIG. 3B. The solid-state lighting body 30 is stimulated by a light source of a lighting element 40 to generate visible light. The lighting element 40 is a blue light laser, a purple light laser, a red light laser, a green light laser or a yellow light laser.

It is noted that the solid-state lighting body of the present invention is a transparent solid-state lighting body, a semi-transparent solid-state lighting body or an opaque solid-state lighting body depending on a ratio of the compositions of the mixed material. According to the transparent or opaque properties, the solid-state lighting body applies to various illumination devices, whereby the light source penetrates or reflects (see FIG. 3A and FIG. 3B, respectively). For example, the opaque solid-state lighting body can apply to form a reflection layer of an illumination device.

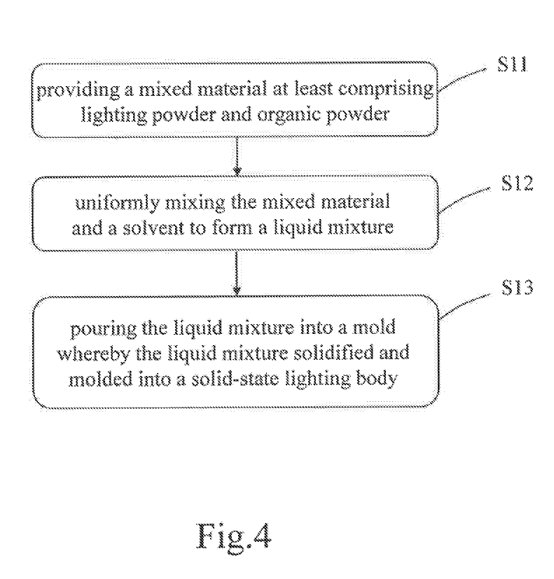

The solid-state lighting body of the abovementioned embodiment is fabricated based on inorganic powder. The solid-state lighting body is also fabricated based on organic powder. Refer to FIG. 4 which is a flowchart diagram schematically showing a method for fabricating a solid-state lighting body according to the second embodiment of the present invention. The steps are detailed as below.

Firstly, in Step S11, lighting powder and organic powder are uniformly mixed to form a mixed material. Based on the mixed material of percentage weight of 100%, the lighting powder has percentage weight of 3-20 wt % and the organic powder has percentage weight of 50-97 wt %. Further, the mixed material comprises glass powder of at most 30 wt %. The lighting powder is selected from fluorescent powder or phosphorescence powder of various lighting colors. For example, the fluorescent powder is yellow fluorescent powder, green fluorescent powder or red fluorescent powder, but the present invention is not limited thereto. Certainly, fluorescent powder and phosphorescence powder are mixed in a fixed ratio to form the lighting powder. The organic powder comprises silicone rubber or epoxy adhesive.

Then, in Step S12, the mixed material and a solvent are uniformly mixed to form a liquid mixture. In the embodiment, a volume ratio of the mixed material to the solvent ranges from 40:50 to 50:50, and the solvent is cleaning naphtha or butanone. During a process of forming the liquid mixture, ball milling is performed on the liquid mixture at a temperature of 10-40° C. for 4-6 hours, whereby the mixed material is uniformly distributed in the liquid mixture.

Then, refer to FIG. 1 and FIG. 2. In Step S13, the liquid mixture 10 is poured into a mold 20 at a room temperature, so that the liquid mixture 10 is solidified and molded to fabricate a final product of the solid-state lighting body 30. Wherein, the mold 20 comprises ceramics, plastic or metal. Besides, in the step of solidifying and molding the liquid mixture 10, the liquid mixture 10 poured into the mold 20 is slowly dried by heat at a temperature of 50° C. for 1 hour and then solidified at a temperature of 150° C. for 1 hour, so as to solidify and mold the liquid mixture 10 into the solid-state lighting body 30.

Finally, the liquid mixture poured into the mold is demolded, as shown in FIG. 3A and FIG. 3B. The solid-state lighting body 30 is stimulated by a light source of a lighting element 40 to generate visible light. The lighting element 40 is a blue light laser, a purple light laser, a red light laser, a green light laser or a yellow light laser.

Similarly, the solid-state lighting body of the present invention is a transparent solid-state lighting body, a semi-transparent solid-state lighting body or an opaque solid-state lighting body depending on a ratio of the compositions of the mixed material. According to the transparent or opaque properties, the solid-state lighting body applies to various illumination devices, whereby the light source penetrates or reflects. For example, the opaque solid-state lighting body can apply to form a reflection layer of an illumination device, thereby achieving the purpose of converting photoluminescence wavelengths.

In a conventional technology, a conventional solid-state lighting body is molded during a high-temperature calcining process, so that lattice structures of fluorescent powder are easily damaged to change lighting properties. The present invention differs from the conventional technology, mixes fluorescent powder, phosphorescence powder, glass powder and either of inorganic powder or organic powder to form the liquid mixture, and fabricates an organic solid-state lighting body or inorganic solid-state lighting body in pour-molding at a room temperature or a low temperature.

Consequently, the method for fabricating the solid-state lighting body of the present invention has a simple fabrication process rather than a complicated high-temperature fabrication process with high energy consumption, and uses simple and cheap equipment with low energy consumption to save the fabrication cost.

In addition, the method for fabricating the solid-state lighting body of the present invention is performed at a lower temperature without damaging lattice structures of lighting material and affecting lighting properties thereof, provides suitable lighting wavelengths, and achieves better lighting efficiency, thereby favoring to improve heat-resistant abilities and lighting abilities of the solid-state lighting body.

Therefore, the fabrication method of the present invention not only achieves simplicity, convenience and the low cost, but also provides a solid-state lighting body having heat-resistant and lighting abilities to efficiently prevent lighting elements from high-temperature cracking due to long-term illumination, thereby apparently increasing reliability and use life. Thus, the present invention can widely apply to various daily illumination of long-term use, fabricate transparent, semi-transparent or opaque solid-state lighting bodies according to the different requirements, such as a reflection layer of an illumination device, and achieve the better efficiency and lower cost to improve industrial competitiveness.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method for forming a solid-state lighting body, which is stimulated by a light source of a lighting element to generate visible light, and said method for fabricating the solid-state lighting body comprising:
providing a mixed material of 100 percentage weight (wt %), and said mixed material at least comprises lighting powder of 3-20 wt % and inorganic powder of 50-97 wt %, and said lighting powder is fluorescent powder, phosphorescence powder or a combination of these, and said inorganic powder comprises calcium sulfate, and either of calcium oxide or silicon dioxide;
uniformly mixing said mixed material and a solvent to form a liquid mixture; and
pouring said liquid mixture into a mold whereby said liquid mixture solidified and molded into said solid-state lighting body.

2. The method for fabricating the solid-state lighting body according to claim 1, wherein said mixed material further comprises glass powder of at most 30 wt %.

3. The method for fabricating the solid-state lighting body according to claim 1, wherein said inorganic powder comprises calcium sulfate of 80-97 wt %, and either of calcium oxide or silicon dioxide of 3-20 wt % based on said inorganic powder of 100 wt %.

4. The method for fabricating the solid-state lighting body according to claim 1, wherein said fluorescent powder is selected from at least one of yellow fluorescent powder, green fluorescent powder and red fluorescent powder.

5. The method for fabricating the solid-state lighting body according to claim 1, wherein a volume ratio of said mixed material to said solvent ranges from 40:50 to 50:50, and said solvent is water.

6. The method for fabricating the solid-state lighting body according to claim 1, wherein after said step of forming said liquid mixture, ball milling is performed on said liquid mixture at a temperature of 10-40□ for 2-4 hours.

7. The method for fabricating the solid-state lighting body according to claim 1, wherein in said step of solidifying and molding said liquid mixture poured into said mold into said solid-state lighting body, said liquid mixture poured into said mold is naturally dried in a shade or dried by heat at a room temperature to a temperature of 50□ for 8-24 hours, so as to solidify and mold said liquid mixture into said solid-state lighting body.

8. The method for fabricating the solid-state lighting body according to claim 1, wherein said mold comprises ceramics, plastic or metal.

9. The method for fabricating the solid-state lighting body according to claim 1, wherein said lighting element is a blue light laser, a purple light laser, a red light laser, a green light laser or a yellow light laser.

10. The method for fabricating the solid-state lighting body according to claim 1, wherein said solid-state lighting body is a transparent solid-state lighting body, a semi-transparent solid-state lighting body or an opaque solid-state lighting body.

11. A method for forming a solid-state lighting body, which is stimulated by a light source of a lighting element to generate visible light, and said method for fabricating the solid-state lighting body comprising:
providing a mixed material of 100 percentage weight (wt %), and said mixed material at least comprises lighting powder of 3-20 wt % and organic powder of 50-97 wt %, and said lighting powder is fluorescent powder, phosphorescence powder or a combination of these, and said organic powder is silicone rubber or epoxy adhesive;
uniformly mixing said mixed material and a solvent to form a liquid mixture; and
pouring said liquid mixture into a mold whereby said liquid mixture solidified and molded into said solid-state lighting body.

12. The method for fabricating the solid-state lighting body according to claim 11, wherein said mixed material further comprises glass powder of at most 30 wt %.

13. The method for fabricating the solid-state lighting body according to claim 11, wherein said fluorescent powder is selected from at least one of yellow fluorescent powder, green fluorescent powder and red fluorescent powder.

14. The method for fabricating the solid-state lighting body according to claim 11, wherein a volume ratio of said mixed material to said solvent ranges from 40:50 to 50:50, and said solvent is cleaning naphtha or butanone.

15. The method for fabricating the solid-state lighting body according to claim 11, wherein after said step of forming said liquid mixture, ball milling is performed on said liquid mixture at a temperature of 10-40° C. for 4-6 hours.

16. The method for fabricating the solid-state lighting body according to claim 11, wherein in said step of solidifying and molding said liquid mixture poured into said mold into said solid-state lighting body, said liquid mixture poured into said mold is dried by heat at a temperature of 50° C. for 1 hour and then solidified at a temperature of 150° C. for 1 hour, so as to solidify and mold said liquid mixture into said solid-state lighting body.

17. The method for fabricating the solid-state lighting body according to claim 11, wherein said mold comprises ceramics, plastic or metal.

18. The method for fabricating the solid-state lighting body according to claim 11, wherein said lighting element is a blue light laser, a purple light laser, a red light laser, a green light laser or a yellow light laser.

19. The method for fabricating the solid-state lighting body according to claim 11, wherein said solid-state lighting body is a transparent solid-state lighting body, a semi-transparent solid-state lighting body or an opaque solid-state lighting body.
